(19) United States
(12) Patent Application Publication
(10) Pub. No.: US 2022/0136907 A1
(43) Pub. Date: May 5, 2022

(54) Floating Temperature Indicating Device

(71) Applicant: Joshua Lawrence Pike, Dallas, TX (US)

(72) Inventor: Joshua Lawrence Pike, Dallas, TX (US)

(21) Appl. No.: 17/517,592

(22) Filed: Nov. 2, 2021

Related U.S. Application Data
(60) Provisional application No. 63/109,830, filed on Nov. 4, 2020.

(51) Int. Cl. G01K 1/024; G01K 1/08; G01K 1/14

(52) U.S. Cl. CPC G01K 1/024; G01K 1/14; G01K 1/08

(57) ABSTRACT

A device is provided for a floating temperature indicating device. The floating temperature indicating device includes a waterproof casing, a temperature sensor, and an illumination system. The waterproof casing is configured to protect the floating temperature indicating device from liquid and cause the floating temperature indicating device to be buoyant. The temperature sensor is configured to measure a temperature of a liquid within which the device is disposed. The illumination system is configured to emit a light corresponding to the temperature of the liquid. The waterproof casing may enclose the temperature sensor or the illumination system.

### RELATED APPLICATION

The present application claims the benefit of U.S. Provisional Application No. 63/109,830 filed Nov. 4, 2020, which is incorporated herein by references in its entirety for all purposes.

### TECHNICAL FIELD

The present disclosure relates generally to temperature display devices. More particularly, this invention relates to a buoyant temperature display device with a light fixture.

### BACKGROUND

A person may desire to know the temperature of a body of liquid. Thermometers designed to measure the temperature of a body of liquid exist, but they often require manual operation by a user. Furthermore, such thermometers typically display the temperature with graduation or with small digital displays which are unsightly, unintuitive, and hard to read from a distance.

### SUMMARY

According to embodiments of the present disclosure, a floating temperature indicating device is provided which substantially eliminates or reduces disadvantages and problems of clearly and intuitively indicating a temperature of a body of water.

In certain embodiments, a floating temperature indicating device may include a waterproof casing, a temperature sensor, and an illumination system. The waterproof casing may enclose the temperature sensor and the illumination system and may be configured to protect the device from liquid and allow the device to float in a liquid. The temperature sensor may be configured to measure a temperature of the liquid. The illumination system may be operable to emit light which corresponds to the temperature of the liquid measured by the temperature sensor. More specifically, the light emitted by the illumination system may correspond to the temperature of the liquid by the color, intensity, or the pattern of light emitted. Furthermore, the illumination system may be composed of at least two light emitting units and a light blending unit to emit a blended light. The device may also be controlled by a control unit which may be a remote-control system. The device may also include a photosensor which may measure the ambient light, and the illumination system may be disabled based on that ambient light signal.

In another embodiment, a floating temperature indicating device may further include a speaker which may emit a sound corresponding to the temperature of the liquid.

In another embodiment, a floating temperature indicating device may include a waterproof casing, a temperature sensor, an illumination system, a speaker, a processor, a power system, and a photosensor. The waterproof casing may enclose the other components of the device and may be configured to protect the device from liquid and allow the device to float in a liquid. The temperature sensor may be configured to measure a temperature of the liquid. The illumination system may be operable to emit light which corresponds to a measured temperature of the liquid. The processor may be coupled to the temperature sensor and the illumination system and control a correspondence scheme between the measured temperature and the light emitted. More specifically, the correspondence scheme may relate color, intensity, or pattern of light emitted to the measured temperature. The speaker may also emit a sound corresponding to the temperature of the liquid. The power system may comprise of a rechargeable battery and a charging unit. The photosensor may measure the ambient light and the processor may be coupled to the photosensor to disable the illumination system based on the ambient light level. In certain specific embodiments, the charging unit may also function as the photosensor.

Particular embodiments of the present disclosure may provide some, none, or all of the following advantages. In certain embodiments, the temperature of the liquid is indicated clearly and intuitively by color, intensity, or pattern of light. In certain embodiments, the device may also be aesthetically pleasing.

Certain embodiments of the present disclosure may include some, all, or none of the above advantages. One or more other technical advantages may be readily apparent to those skilled in the art from the figures, descriptions, and claims included herein.

### BRIEF DESCRIPTION OF DRAWINGS

For a more complete understanding of this disclosure and its features, reference is now made to the following description, taken in conjunction with the accompanying drawings, in which:

FIG. 1 illustrates a view of an exemplary implementation of a floating temperature indicating device with the device in a pool of water.

FIG. 2 illustrates a view of an exemplary implementation of a floating temperature indicating device.

FIG. 3 is an exploded view of the exemplary implementation of a floating temperature indicating device from FIG. 2.

FIG. 4 is an underside view of a top waterproof casing of the exemplary implementation of a floating temperature indicating device from FIG. 2.

FIG. 5 is a side view of internal stack of the exemplary implementation of a floating temperature indicating device from FIG. 2.

FIG. 6 is a side view of the bottom waterproof casing of the exemplary implementation of a floating temperature indicating device from FIG. 3

FIG. 7 is a bottom view of an alternate bottom waterproof casing.

FIG. 8 is a view of an alternate exemplary implementation of a floating temperature indicating device.

### DETAILED DESCRIPTION

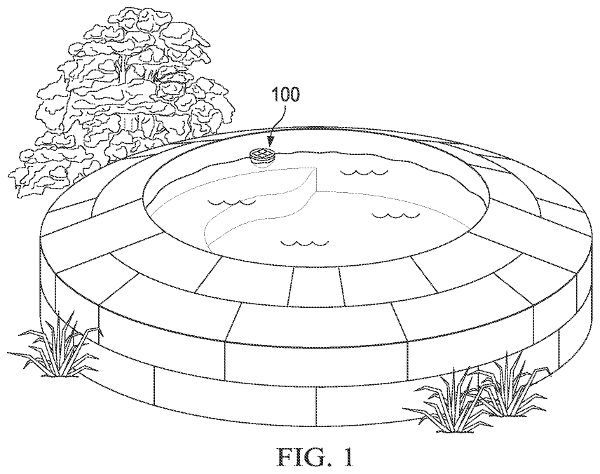

FIGS. 1-8 depict embodiments of a floating temperature indicating device that indicates the temperature of a liquid clearly and intuitively. In the following descriptions, like numbers refer to like elements.

FIG. 1 is a view of an exemplary implementation of a floating temperature indicating device 100. In this implementation, the floating temperature indicating device 100 is designed to be operated in an enclosed body of water such as a pool, hot tub, or a bathtub, or any other suitable body of water which may include a person. The floating temperature indicating device 100 may also be designed to be operated in liquids other than water. The floating temperature indicating device 100 may also be scaled down to be operated in smaller bodies of water such as a cup of tea. The floating temperature indicating device 100 floats on a liquid and can be left to float in the liquid and may operate continuously. The floating temperature indicating device 100 indicates a temperature of a liquid by emitting a light. It may do so by emitting a corresponding color, intensity or pattern of light emitted to the temperature of the liquid. For example, the floating temperature indicating device 100 may emit a constant, dim blue light when the liquid is below the ideal temperature for a soak in a hot tub and a constant, a constant purple light when the liquid is at the ideal temperature, and a flashing, bright red light when the liquid is above the ideal temperature. The floating temperature indicating device 100 may also indicate the temperature by emitting a sound. For example, the device may emit an alarm if the temperature of the liquid is dangerously high.

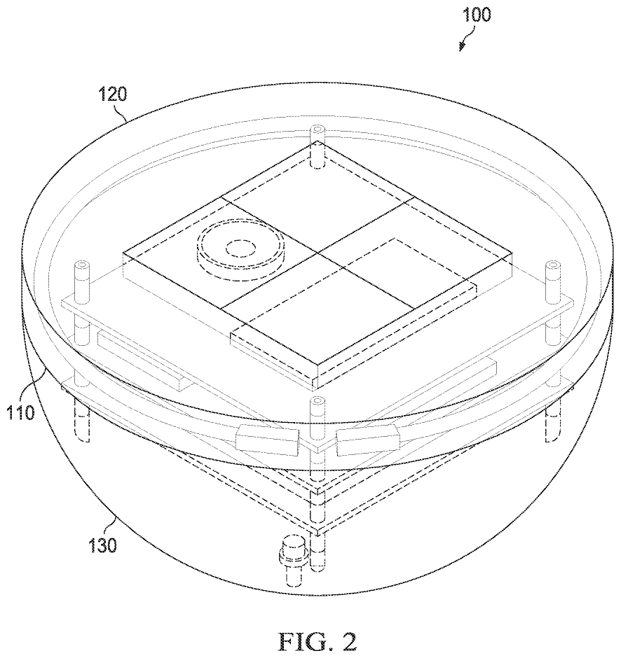

FIG. 2 is a view of an exemplary implementation of the floating temperature indicating device 100. A waterproof casing 110 encloses the device. The waterproof casing 110 may be made of transparent or translucent material and the internal components may be visible through it. The waterproof casing 110 comprises of a top waterproof casing 120 and a bottom waterproof casing 130. The top waterproof casing 120 may be in the shape of a circular plate. The bottom waterproof casing 130 may be in the shape of a half sphere. The top waterproof casing 120 and the bottom waterproof casing 130 may be connected by silicone, waterproof glue, or other connecting methods that allows the waterproof casing 110 to protect the components within floating temperature indicating device 100 by preventing any liquid from entering the waterproof casing 100.

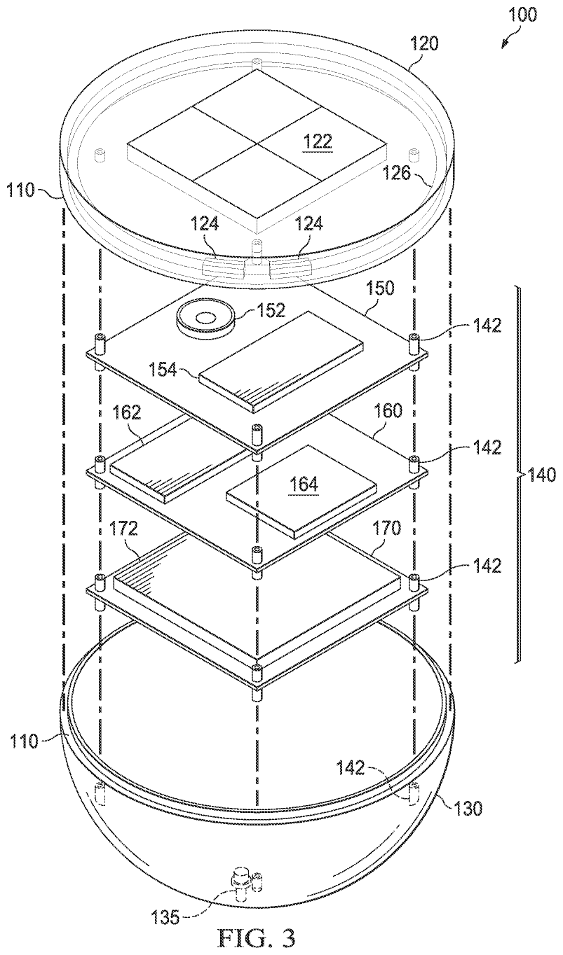

FIG. 3. is an exploded view of an exemplary implementation of the floating temperature indicating device 100. As shown, the floating temperature indicating device 100 broadly comprises of the waterproof casing 110 and internal stack 140. The waterproof casing 110 may comprise of the top waterproof casing 120 and the bottom waterproof casing 130. In certain embodiments, the internal stack 140 may comprise first insert 150, second insert 160, and a third insert 170. The inserts are not necessary to the device but may provide structure to various components within the device if additional support is desired.

The top waterproof casing 120 may include a charging unit 122 and an illumination system 124. The charging unit 122 may be an array of solar panels comprising of at least one solar panel. The charging unit 122 may also function as a photosensor. The array of solar panels may measure an ambient light level. Then, the array of solar panels may generate an ambient light signal based on the ambient light level which disables the illumination system 124. This conserves power by disabling the illumination system 124 in a high ambient light level where light emitted by the illumination system 124 may not be noticeable. The charging unit 122 may be positioned towards the top of the floating temperature indicating device 100 to optimize its performance. The floating temperature indicating device 100 may also be weighed so that the charging unit 122 is in the optimal position.

The bottom waterproof casing 130 may include a temperature sensor 135. The temperature sensor 135 may comprise of a thermocouple, a thermistor, or any other suitable temperature sensor. The temperature sensor 135 may be inside or outside the waterproof casing 100. The temperature sensor 135 may be fixed to the waterproof casing 100 by silicone, waterproof glue, or other connecting methods that prevents any liquid from entering the waterproof casing 100 such that a portion of the temperature sensor 135 is exposed to the liquid. The temperature sensor 135 may be positioned towards the bottom of the floating temperature indicating device 100 to optimize measurement of the temperature of the liquid. The floating temperature indicating device 100 may also be weighed so that the temperature sensor 135 is in the optimal position to measure the temperature of the liquid.

The illumination system 124 comprises of at least one light emitting unit 124 and at least one light bending unit 126. The light emitting unit 124 may comprise of light emitting diodes and may emit different color, patterns, and intensities of light. The light emitting unit 124 emits the light into the light bending unit 126 which combines and disperses the light. Light bending unit 126 may make the light more aesthetic or more visible by dispersing the light. Light bending unit 126 may also create a transitory light by combining the different colored light emitted by the light emitting unit 124. Thus, the light illumination system 124 can emit different color, intensity, or pattern of light which can correspond to and indicate the temperature of the liquid.

In an exemplary embodiment, the internal stack 140 comprises of a first insert 150, a second insert 160, and a third insert 170. The three inserts provide a structure on which components can be mounted. The three inserts may be connected to the waterproof casing 110 and each other by coupling elements 142 at the corners of the inserts. The top waterproof casing 120 and the bottom waterproof casing 130 may also comprise of coupling elements 142 to couple to the inserts. The coupling elements 142 may comprise of a hollow cylinder with a screw going through them.

As an example, the first insert 150 may hold a speaker 152 and a processor 154. The speaker 152 may indicate the temperature of the liquid by emitting a sound corresponding to the temperature of the liquid. The speaker 152 may also emit a sound indicating the status of the floating temperature indicating device 100. For example, the speaker 152 may emit an alarm if the power of the floating temperature indicating device 100 is low. The processor 154 may be comprised of a microprocessor. The processor 154 may be operatively coupled to at least the temperature sensor 135 and the illumination system 124 and control the illumination system based on a correspondence scheme between the temperature sensor 135 and the illumination system 124. The correspondence scheme may relate the color, the intensity, or the pattern of the light emitting by the illumination system 124 with the temperature of the liquid measured by the temperature sensor 135. The processor may be operatively coupled and control the other components of the floating temperature indicating device 100. For example, the processor may be coupled to the charging unit 122 and the illumination system 124 and disable the illumination system 124 based on the ambient light signal generated by the charging unit 122.

The second insert 160 may hold a charging circuit 162 and a control unit 164. The charging circuit 162 is a part of the power system comprising a rechargeable battery 172, charging circuit 162, and the charging unit 122. The control unit 164 in this implementation is a remote-control system comprising of a Bluetooth receiver. The control unit 164 may also comprise of a button, a Wi-Fi receiver, or another control system. The control unit 164 receives external signals and may control at least one behavior of the device. The control unit 164 may be operatively coupled to an external remote or a smartphone application as a source of the external signals. The control unit may be operatively coupled to the processor 154, and the control unit 164 may control such behaviors as the correspondence scheme between the temperature sensor 135 and the illumination system 124.

The third insert 170 may hold the rechargeable battery 172. The rechargeable battery powers the floating temperature indicating device 100 and is charged by the charging unit 122. The rechargeable battery 172 may comprise of a lithium-ion battery. Although certain components of internal stack 140 are discussed as being on certain inserts, each component of internal stack 140 may be on any suitable insert (e.g., first insert 150, second insert 160, third insert 170, etc.). Also, although certain components are not discussed as being on certain inserts, each component of the floating temperature indicating device 100 may be on any suitable insert. For example, the charging unit 122 and illumination system 124 may be on the first insert instead of the top waterproof casing.

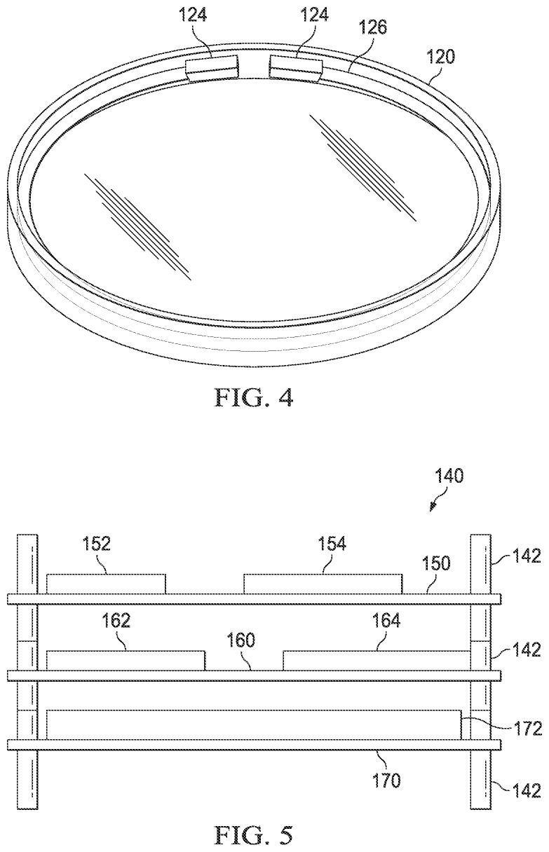

FIG. 4 illustrates the bottom view of the top waterproof casing 120. The charging unit 122 is omitted. The light emitting unit 124 and the light bending unit 126 are arranged around the internal circumference of the top waterproof casing 120.

FIG. 5 is a side view of the internal stack 140. The inserts are stacked on top of each other and coupled by the coupling elements 142.

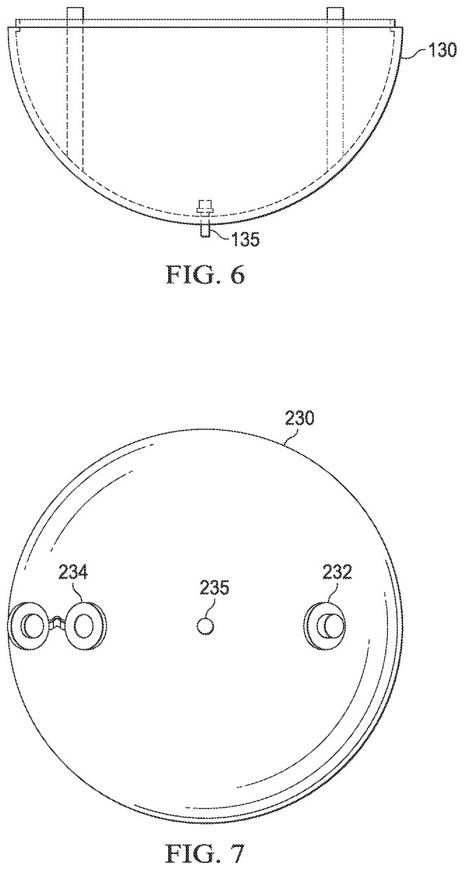

FIG. 6 is a side view of the bottom waterproof casing 130. This view shows the temperature sensor 135 fixed to the bottom of the bottom waterproof casing 130 such that a portion of the temperature sensor 135 is exposed to the liquid. The bottom waterproof casing may also comprise an extending coupling element 142 which may couple the bottom waterproof casing 130 to the inserts.

FIG. 7 is a bottom view of an alternate implementation of the bottom waterproof casing 230. This implementation includes a control unit 232 and a charging unit 234. In this implementation, the control unit 232 is a button. The presses of the button may control at least one behavior of the floating temperature indicating device 100. The control unit 232 may be operatively coupled to the processor, and the control unit 164 may control such behaviors as the correspondence scheme between the temperature sensor 135 and the illumination system 124. In this implementation, the charging unit 234 is a charging port. The charging unit 234 as a charging port may supplement or replace charging unit 122 which is a solar panel. The charging unit 234 may allow the use of the floating temperature indicating device 100 where charging from solar panels may be insufficient such as in bad weather or indoors.

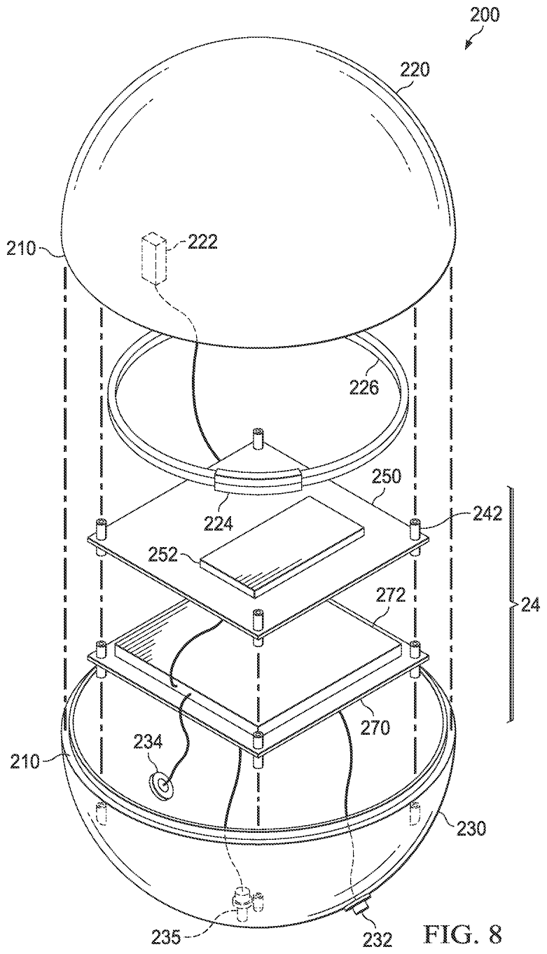

FIG. 8 is an alternate implementation of the floating temperature indicating device 200. The floating temperature indicating device 200 is comprised of a waterproof casing 210 and internal stack 240. The waterproof casing 210 is comprised of a top waterproof casing 220 and the bottom waterproof casing 230. A photosensor 222 and a illumination system 224 rests below the top waterproof casing 220. The photosensor 222 generates an ambient light signal based on the ambient light level which may disable the illumination system 224. This conserves power by disabling the illumination system 224 in a high ambient light level where light emitted by the illumination system 224 may not be noticeable.

The illumination system 224 is comprised of a light emitting unit 224 and a light blending unit 226. The light emitting unit 224 may comprise of light emitting diodes and may emit different color, patterns, and intensities of light. The light emitting unit 224 emits the light into the light bending unit 226 which combines and disperses the light. Light bending unit 226 may make the light more aesthetic or more visible by dispersing the light. Light bending unit 226 may also create a transitory light by combining the different colored light emitted by the light emitting unit 224. Thus, the light illumination system 224 can emit different color, intensity, or pattern of light which can correspond to and indicate the temperature of the liquid.

The bottom waterproof casing 230 may hold the temperature sensor 235, the control unit 232 and the charging unit 234 as discussed in paragraph describing FIG. 7.

The internal stack 240 are comprised of a first insert 250 and a second insert 270. The first insert 250 may hold a processor 252. The processor 254 may be comprised of a microprocessor. The processor 254 may be operatively coupled to at least the temperature sensor 235 and the illumination system 224 and control the illumination system based on a correspondence scheme between the temperature sensor 235 and the illumination system 224. The correspondence scheme may relate the color, the intensity, or the pattern of the light emitting by the illumination system 224 with the temperature of the liquid measured by the temperature sensor 235. The processor may be operatively coupled and control the other components of the floating temperature indicating device 100. For example, the processor may be coupled to the photosensor 222 and the illumination system 224 and disable the illumination system 224 based on the ambient light signal generated by the photosensor 222.

The second insert 270 may hold a rechargeable battery 272. The rechargeable battery powers the floating temperature indicating device 200 and is charged by the charging unit 234. The rechargeable battery 272 may comprise of a lithium-ion battery.

1. A floating temperature indicating device comprising:
a) a waterproof casing configured to protect the floating temperature indicating device from liquid and cause the floating temperature indicating device to be buoyant;
b) a temperature sensor configured to measures a temperature of a liquid within which the device is disposed and generates a temperature signal based on the measured temperature;
c) an illumination system comprising at least two light emitting units configured to emit at least two different color lights at variable intensities coupled to a light blending unit which combines and disperses the different color lights emitted by the light emitting units to emit a transitional light;
d) a speaker operable to emit a sound corresponding to the temperature of the liquid;
e) a processor operatively coupled to said temperature sensor and said illumination system that controls the illumination system based on a correspondence scheme with the temperature sensor;
f) a power system comprising a rechargeable battery and a charging unit operable to charge the rechargeable battery; and
g) a photosensor capable of measuring an ambient light level and operatively coupled to the processor such that the processor can disable the illumination system based on the ambient light level;
h) wherein said waterproof casing encloses said temperature sensor, said illumination system, said processor, said power system, and said photosensor.

2. The device of claim 1 wherein the correspondence scheme relates a color of the transitional light emitted to the temperature of the liquid.

3. The device of claim 1 wherein the correspondence scheme relates an intensity of the transitional light emitted to the temperature of the liquid.

4. The device of claim 1 wherein the correspondence scheme relates a pattern of the transitional light emitted to the temperature of the liquid.

5. The device of claim 1 wherein the charging unit also function as the photosensor.

6. A floating temperature indicating device comprising:
a) a waterproof casing configured to protect the floating temperature indicating device from liquid and cause the floating temperature indicating device to be buoyant;
b) a temperature sensor configured to measure a temperature of a liquid within which the device is disposed and generates a temperature signal based on the measured temperature;
c) an illumination system operable to emit a light corresponding to the temperature of the liquid; and
d) a speaker operable to emit a sound corresponding to the temperature of the liquid;
e) wherein said waterproof casing encloses at least one of said temperature sensor and said illumination system.

7. The device of claim 6 wherein the light emitted by the illumination system corresponds to the temperature of the liquid by a color of the light emitted.

8. The device of claim 6 wherein the light emitted by the illumination system corresponds to the temperature of the liquid by an intensity of the light emitted.

9. The device of claim 6 wherein the light emitted by the illumination system corresponds to the temperature of the liquid by a pattern of the light emitted.

10. The device of claim 6 wherein the illumination system comprises:
a) at least two light emitting units each configured to emit a different color light at variable intensities; and
b) a light blending unit which combines and disperses the different color lights emitted by the light emitting units.

11. The device of claim 6 further comprising a control unit to control at least one behavior of the device.

12. The device of claim 6 further comprising:
a) a rechargeable battery; and
b) a charging unit operable to charge the rechargeable battery.

13. A floating temperature indicating device comprising:
a) a waterproof casing configured to protect the floating temperature indicating device from liquid and cause the floating temperature indicating device to be buoyant;
b) a temperature sensor configured to measure a temperature of a liquid within which the device is disposed and generates a temperature signal based on the measured temperature; and
c) an illumination system operable to emit a light corresponding to the temperature of the liquid;
d) wherein said waterproof casing encloses at least one of said temperature sensor and said illumination system.

14. The device of claim 13 wherein the light emitted by the illumination system corresponds to the temperature of the liquid by a color of the light emitted.

15. The device of claim 13 wherein the light emitted by the illumination system corresponds to the temperature of the liquid by an intensity of the light emitted.

16. The device of claim 13 wherein the light emitted by the illumination system corresponds to the temperature of the liquid by a pattern of the light emitted.

17. The device of claim 13 wherein the illumination system comprises:
a) at least two light emitting units each configured to emit a different color light at variable intensities; and
b) a light blending unit which combines and disperses the different color lights emitted by the light emitting units.

18. The device of claim 13 further comprising a control unit to control at least one behavior of the device.

19. The control unit of claim 18 wherein the control unit is a remote-control system.

20. The device of claim 13 further comprising:
a photo sensor configured to measure ambient light and generates an ambient light signal based on the ambient light level wherein the illumination system is disabled based on the ambient light signal.
